(19) United States
(12) Patent Application Publication
(10) Pub. No.: US 2009/0327033 A1
(43) Pub. Date: Dec. 31, 2009

(54) METHODS AND SYSTEMS FOR FORECASTING INVENTORY LEVELS IN A PRODUCTION ENVIRONMENT

(75) Inventors: Sudhendu Rai, Fairport, NY (US); John C. Handley, Fairport, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/146,635

(22) Filed: Jun. 26, 2008

(51) Int. Cl. G06Q 10/00

(52) U.S. Cl. 705/10; 705/28

(57) ABSTRACT

A method of maintaining an inventory of a consumable in a production environment may include identifying a demand distribution for a consumable in a production environment, identifying a lead time period for replenishing the consumable and selecting, from a plurality of candidate parameters, a control parameter that is a function of total inventory management cost so that the selected control parameter corresponds to a lowest determined total inventory management cost. The method may also include using a forecasting model to automatically forecast a total future demand value for the consumable based on the demand distribution, the lead time period and a standard error of forecasting adjusted by the selected control parameter, determining whether additional inventory is needed based on at least the total forecasted future demand value and an inventory position and, if additional inventory is needed, generating an order for the consumable.

### REFERENCE TO RELATED APPLICATIONS

This application is related to U.S. patent application Ser. No. 12/______ (attorney docket no. 20070917-US-NP/121782.21401).

### BACKGROUND

It is common for print shops in an enterprise to experience fluctuating job demand. Due to the variability in job demand, an enterprise must maintain a certain level of inventory, such as ink, paper and the like, in anticipation of the jobs the enterprise will receive. This inventory level is usually significant because the enterprise must maintain an inventory level necessary to process its largest jobs even if these jobs are received infrequently.

Static inventory policies that estimate future demand based on a constant or independently and identically distributed demand, such as (r,Q) “reorder quantity”, (r,T) “reorder to target” or (s,S) policies, are known in the art and described in, for example Simchi Levi et al., Designing & Managing the Supply Chain. However, these policies ignore the fact that true demand distribution often varies. Because demand distributions change over time, and demand at different times is often correlated, the inventory estimates produced by static inventory polices are often inaccurate. When forecasting methods are used, inaccurate forecasts lead to uncertain estimates of demand, which often result in excess safety stock and increased costs.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “consumable” is a reference to one or more consumables and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In an embodiment, a method of maintaining an inventory of a consumable in a production environment may include identifying a demand distribution for a consumable in a production environment, identifying a lead time period for replenishing the consumable and selecting, from a plurality of candidate parameters, a control parameter that is a function of total inventory management cost so that the selected control parameter corresponds to a lowest determined total inventory management cost. The method may also include using a forecasting model to automatically forecast a total future demand value for the consumable based on the demand distribution, the lead time period and a standard error of forecasting adjusted by the selected control parameter, determining whether additional inventory is needed based on at least the total forecasted future demand value and an inventory position and, if additional inventory is needed, generating an order for the consumable.

In an embodiment, a method of maintaining an inventory of a consumable in a print production environment may include identifying a demand distribution for a consumable in a print production environment. A consumable may include one or more of ink, paper, toner, envelopes, wire and binding materials. The method may also include identifying a lead time period for replenishing the consumable, where the lead time period includes one or more days. The method may include selecting, from a plurality of candidate parameters, a control parameter that is a function of total inventory management cost so that the selected control parameter corresponds to a lowest determined total inventory management cost, using a forecasting model to automatically forecast a total future demand value for the consumable based on the demand distribution, the lead time period and a standard error of forecasting adjusted by the selected control parameter and if the total future demand value exceeds an inventory position, generating an order for the consumable.

In an embodiment, a system of maintaining an inventory of a consumable in a production environment may include a processor and a processor readable storage medium in communication with the processor. The processor readable storage medium may contain one or more programming instructions for identifying a demand distribution for a consumable in a production environment, identifying a lead time period for replenishing the consumable, and selecting, from a plurality of candidate parameters, a control parameter that is a function of total inventory management cost so that the selected control parameter corresponds to a lowest determined total inventory management cost. The processor readable storage medium may also contain one or more programming instructions for using a forecasting model to automatically forecast a total future demand value for the consumable based on the lead time period and a standard error of forecasting adjusted by the selected control parameter, determining whether additional inventory is needed based on at least the total forecasted future demand value and an inventory position, and if additional inventory is needed, generating an order for the consumable.

### BRIEF DESCRIPTION OF THE DRAWINGS

Aspects, features, benefits and advantages of the present invention will be apparent with regard to the following description and accompanying drawings, of which:

FIG. 1 depicts a flow chart of an exemplary method of maintaining inventory of a consumable in a production environment according to an embodiment.

FIG. 2 depicts an exemplary demand distribution according to an embodiment.

FIG. 3 illustrates a block diagram of exemplary internal hardware that may be used to contain or implement the program instructions according to an embodiment.

### DETAILED DESCRIPTION

For purposes of the discussion below, a “job” refers to a logical unit of work that is to be completed for a customer. A job may include one or more print jobs from one or more clients.

A “print job” refers to a job processed in a print production system. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “resource” is a device that performs a processing function on a job. For example, in a print production environment, a resource may include a printer, a copier, a binder, a hole-punch, a collator, a sealer or any other equipment used to process print jobs.

A “print shop” refers to an entity that includes a plurality of document production resources, such as printers, cutters, collators and the like. A print shop may be a freestanding entity, including one or more print-related devices, or it may be part of a corporation or other entity. Additionally, a print shop may communicate with one or more servers by way of a local area network or a wide area network, such as the Internet, the World Wide Web or the like.

An “enterprise” is a production environment that includes multiple items of equipment to manufacture and/or process jobs that may be customized based on customer requirements. For example, in a print production environment, an enterprise may include a plurality of print shops.

An “inventory position” is the inventory at a storage location, such as a warehouse, plus any inventory that has been ordered but not yet delivered minus inventory that is backordered.

An “inventory policy” is an analysis of costs, levels, areas of risk and the like associated with a production environment's position.

A “lead time period” is the inventory replenishment time from a supplier in days.

“Job demand information” is the job volume associated with a production environment over a certain time period. For example, in a print production environment, job demand information may include print job volume associated with a print shop over a certain time period.

A “consumable” is an item that is utilized by a production environment in the processing of jobs. A consumable's inventory may be depleted by the use of the consumable. In a print production environment, a consumable may include ink, paper, toner, wire for staples, envelopes, binding materials and/or the like.

A “demand distribution” is a distribution of demand associated with a consumable over a period of time.

A “total future demand value” is an estimated amount of inventory associated with a consumable that may be needed by a production environment to process jobs over a period of time.

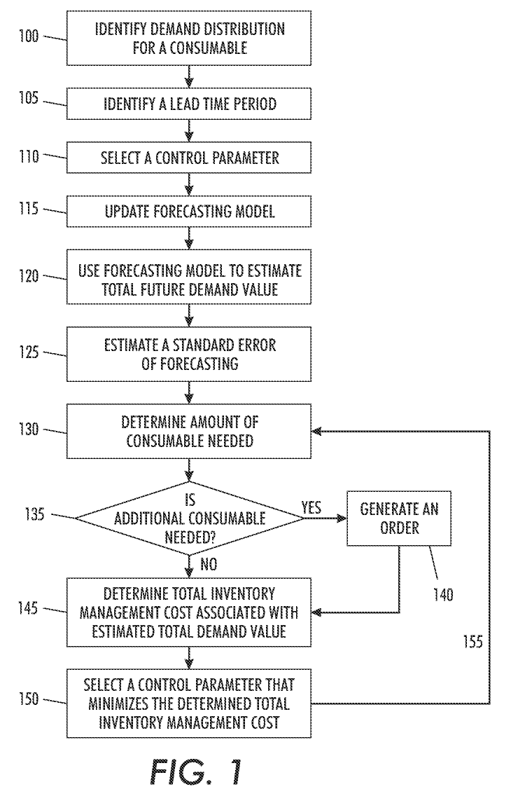

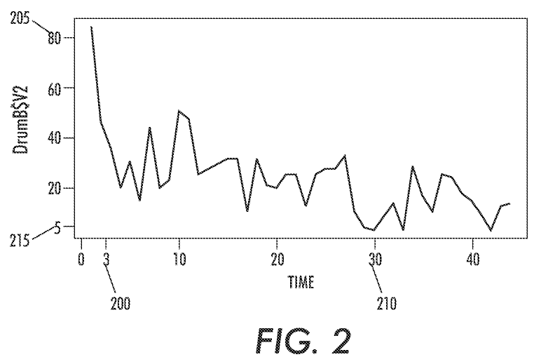

FIG. 1 illustrates a flow chart of an exemplary method of maintaining an inventory of a consumable in a production environment according to an embodiment. A demand distribution for a consumable in a production environment may be identified 100. In an embodiment, a demand distribution for a consumable may be determined by aggregating the demand for a consumable over a period of time. The demand distribution may be represented by the time series d(i), where i denotes the i^{th} point in the time series. FIG. 2 illustrates an exemplary demand distribution according to an embodiment. As illustrated, the demand associated with the consumable is variable. For example, the demand corresponding to day 3 200 is approximately 80 units 205, whereas the demand associated with day 30 210 is approximately 5 units 215.

Referring back to FIG. 1, in an embodiment, a lead time period for replenishing a consumable may be identified 105. A lead time period may refer to an amount of time required for a supplier to replenish the consumable. For example, the lead time period associated with black ink in a print production environment may be three days if an order to replenish black ink placed today would be delivered in three days. In an embodiment, the lead time may depend on one or more of the consumable type, the supplier, the time of year and the like.

In an embodiment, a control parameter may be selected 110. The control parameter may be selected from a plurality of control parameters. In an embodiment, the plurality of control parameters may be within a predetermined range. The selected control parameter may be a function of total inventory management cost and may correspond to a lowest determined total inventory management cost. In an embodiment, a lowest determined total inventory management cost may be determined by using historical demand data, and selecting the value that minimizes cost over the historical demand data.

In an embodiment, a total inventory management cost may represent the cost incurred by a production environment associated with maintaining a consumable. A total inventory management cost may be, for example, the aggregate of an ordering cost, a holding cost and a penalty cost. An ordering cost may be the total expense incurred in placing an order for the consumable. A holding cost may be the total expense incurred in warehousing the consumable. A penalty cost may be the total expense incurred when the inventory held by a production environment is insufficient to meet the demand.

In an embodiment, a forecasting model may be used to automatically forecast a total future demand value for the consumable. A total future demand value is an estimated amount of inventory associated with a consumable that may be needed by a production environment to process jobs over a period of time. In an embodiment, a forecasting model may be updated 115 based on the identified demand distribution. For example, a forecasting model may be fitted to the demand distribution.

In an embodiment, a forecasting model may estimate 120 a total future demand value for a consumable over a certain time period. For example, a forecasting model may be used to forecast the amount of a consumable needed over a certain number of lead time periods.

In an embodiment, a forecasting model may forecast a future demand value for each day in an associated period. For example, a future demand value may be forecasted for each day in the lead period. An aggregate future demand value for the consumable may be the aggregate of the future demand values associated with each day in the period. Table 1 illustrates exemplary future demand values associated with each day in a five day period. As illustrated by Table 1, the aggregate future demand value associated with the consumable over the five day period is sum of the future demand values for each day in the period.

TABLE 1

| Day | Future Demand Value |
|---|---|
| 1 | 12 |
| 2 | 4 |
| 3 | 8 |
| 4 | 19 |
| 5 | 7 |
| Aggregate Future | 50 |
| Demand Value | |

In an embodiment, the forecasting model that is used may depend on whether a demand distribution exhibits a seasonal component. A seasonal component may refer to one or more variations in a demand distribution that recur every year to relatively the same extent. For example, if the demand for white paper is relatively low in July for several consecutive years, the demand distribution for white paper may have a seasonal component.

In an embodiment, past demand data associated with a consumable may be analyzed to determine whether a demand distribution exhibits a seasonal component. An auto-correlation function of a demand distribution may describe the correlation between the distribution at different points in time. In an embodiment, an auto-correlation function of a demand distribution associated with a consumable may be observed to determine whether a value of the lag of the auto-correlation value is greater than a predetermined threshold. If so, the demand distribution may exhibit a seasonal component.

Demands d(i) and d(i-k) may be separated by a lag of k time units. When demand has a seasonal component of lag k, demands d(i) and d(i-k) may be highly correlated for i=1, 2, 3, . . . n. Whether demand has a seasonal component may be determined by testing whether an auto correlation function (“ACF”) exceeds a fixed threshold for some value of k. An ACF may be defined as:

$$acf ( k ) = \frac{{\sum }_{i = k + 1}^{n} ( ( d ( i ) - \overline{d} ) ( d ( i - k ) - \overline{d} ) )}{{\sum }_{i = 1}^{n} {( d ( i ) - d )}^{2}}$$

Examples of forecasting models include, without limitation, the auto-regressive integrated moving average (ARIMA) model and the seasonal auto-regressive integrated moving average (SARIMA) model. ARIMA may be used to forecast the future demand associated with a consumable having a demand distribution without a seasonal component. SARIMA may be used to forecast the future demand associated with a consumable having a demand distribution with a seasonal component.

In addition, a forecasting model may be used to estimate 125 a standard error of forecasting. In an embodiment, a standard error of forecasting may represent the variability associated with the forecasted future demand. A standard error of forecasting may be used to adjust a control parameter in order to more accurately estimate the amount of a consumable that is needed. In an embodiment, an estimate of an amount of a consumable that is needed may be determined 130. In an embodiment, the estimate of the amount of consumable that is needed may be represented by the sum of the difference between the aggregate future demand value and the inventory position and the product of the standard error of forecasting and the control parameter as illustrated by the following:

aggregate future demand value+(standard error of forecasting*control parameter)

In an embodiment, an adjusted total future demand value may be represented by the difference between the aggregate future demand value and the inventory position. An adjusted standard error of forecasting may be determined by multiplying the standard of error of forecasting and the selected control parameter. The total future demand value may be determined by summing the adjusted future demand value and the adjusted standard of error. For example, if the aggregate demand value for colored ink is 50 cartridges, the standard error of forecasting is 5 cartridges and the control parameter is 3, then the amount of cartridges of colored ink that may be necessary over a certain period of time is 65 cartridges (i.e., 50+(5*3)).

In an embodiment, the total forecasted future demand value may be used to determine 135 whether additional inventory of a consumable is needed. The total future forecasted demand value may be compared to an inventory position associated with the consumable. An inventory position is the inventory currently held at a storage location, such as a warehouse, plus any inventory that has been ordered but not yet delivered minus inventory that is backordered. For example, a print production environment may have 50 color ink cartridges in stock and 20 color ink cartridges may have been ordered but not yet delivered. In addition, 15 color ink cartridges may be backordered. As such, the inventory position associated with color ink cartridges is 55 cartridges (i.e., 50+20−15).

If additional inventory is needed, an order for the consumable may be generated 140. In an embodiment, if the total forecasted future demand value equals or exceeds the inventory position, an order for the consumable may be placed 140. The order may be for an amount of the consumable equal to the difference between the total forecasted future demand value and the inventory position. For example, if the total forecasted future demand value associated with white paper is 70 boxes and the inventory position is 50 boxes, then an order may be generated 140 for 20 boxes so the production environment can meet the forecasted demand. In an embodiment, if the total forecasted future demand value exceeds the inventory position, an order for an amount of the consumable greater than the difference between the total forecasted future demand value and the inventory position may be placed 140.

In an embodiment, if the total forecasted future demand value equals or is less than the inventory position, an order for the consumable may be placed 140. The order may be for a predetermined amount of the consumable. For example, if the total forecasted future demand value equals the inventory position, an order for five units of the consumable may be placed to ensure that the production environment can meet its orders should the actual demand exceed the forecasted demand.

In an embodiment, an order may be generated 140 if the total forecasted future demand value exceeds the inventory position value by a predetermined amount. For example, an order may be generated 140 if the total forecasted future demand value exceeds the inventory position value by five or fewer units. In an embodiment, the order may be for a predetermined amount of the consumable. For example, if the total forecasted future demand value exceeds the inventory position value by five or fewer units, an order for five units of the consumable may be placed 140. Alternatively, if the inventory position value equals or exceeds the total forecasted future demand value, an order for the consumable may not be placed.

A total inventory management cost associated with the estimated total forecasted future demand value may be determined 145. In an embodiment, the total inventory management cost may be a function of a control parameter and may be represented by:

T(λ)=order costs for all orders+material cost of inventory+holding costs for inventory+penalty cost for stockouts

The value of the control parameter that minimizes the total inventory policy cost may be selected 150. The control parameter may be selected 150 from a plurality of control parameters. In an embodiment, the plurality of control parameters may be within a predetermined range. The selected control parameter may correspond to a lowest determined total inventory management cost. In an embodiment, a lowest determined total inventory management cost may be determined by using historical demand data, and selecting the value that minimizes cost over the historical demand data. In an embodiment, the selected control parameter may be used to determine 155 a subsequent estimate of an amount of a consumable that is needed.

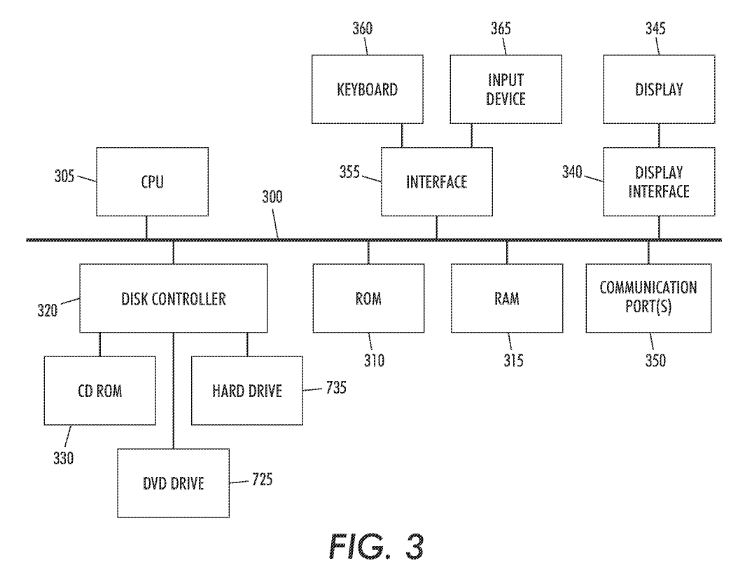

FIG. 3 depicts a block diagram of exemplary internal hardware that may be used to contain or implement the program instructions according to an embodiment. A bus 300 serves as the main information highway interconnecting the other illustrated components of the hardware. CPU 305 is the central processing unit of the system, performing calculations and logic operations required to execute a program. Read only memory (ROM) 310 and random access memory (RAM) 315 constitute exemplary memory devices.

A disk controller 320 interfaces with one or more optional disk drives to the system bus 300. These disk drives may include, for example, external or internal DVD drives 325, CD ROM drives 330 or hard drives 335. As indicated previously, these various disk drives and disk controllers are optional devices.

Program instructions may be stored in the ROM 310 and/or the RAM 315. Optionally, program instructions may be stored on a tangible computer readable medium such as a compact disk or a digital disk or other recording medium.

An optional display interface 340 may permit information from the bus 300 to be displayed on the display 345 in audio, graphic or alphanumeric format. Communication with external devices may occur using various communication ports 350. An exemplary communication port 350 may be attached to a communications network, such as the Internet or an intranet.

In addition to the standard computer-type components, the hardware may also include an interface 355 which allows for receipt of data from input devices such as a keyboard 360 or other input device 365 such as a mouse, a touch screen, a remote control, a pointer and/or a joystick.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of maintaining an inventory of a consumable in a production environment, the method comprising:
identifying a demand distribution for a consumable in a production environment;
identifying a lead time period for replenishing the consumable;
selecting, from a plurality of candidate parameters, a control parameter that is a function of total inventory management cost so that the selected control parameter corresponds to a lowest determined total inventory management cost;
using a forecasting model to automatically forecast a total future demand value for the consumable based on the demand distribution, the lead time period and a standard error of forecasting adjusted by the selected control parameter;
determining whether additional inventory is needed based on at least the total forecasted future demand value and an inventory position; and
if additional inventory is needed, generating an order for the consumable.

2. The method of claim 1, further comprising:
determining whether the demand distribution comprises a seasonal component; and
if so, selecting, as the forecasting model, a forecasting model having a seasonal component.

3. The method of claim 2, wherein selecting the forecasting model comprises selecting a SARIMA forecasting model.

4. The method of claim 1, wherein the lead time comprises one or more days.

5. The method of claim 1, wherein using a forecasting model to automatically forecast a total future demand value comprises:
determining an aggregate future demand value by summing a future demand value for each day in the lead time period;
determining an adjusted standard error of forecasting by multiplying the standard error of forecasting and the selected control parameter; and
forecasting the total future demand value by summing the aggregate future demand value and the adjusted standard error of forecasting.

6. The method of claim 1, wherein determining whether additional inventory is needed comprises:
determining whether the total forecasted future demand value exceeds the inventory position.

7. The method of claim 1, wherein the total inventory management cost comprises a sum of a fixed ordering cost, a holding cost and a penalty cost.

8. The method of claim 1, wherein generating an order for the consumable comprises generating an order for an amount of the consumable equal to a difference between the inventory position and the total forecasted future demand.

9. A method of maintaining an inventory of a consumable in a print production environment, the method comprising:
identifying a demand distribution for a consumable in a print production environment, wherein the consumable comprises one or more of ink, paper, toner, envelopes, wire and binding materials;
identifying a lead time period for replenishing the consumable, wherein the lead time period comprises one or more days;
selecting, from a plurality of candidate parameters, a control parameter that is a function of total inventory management cost so that the selected control parameter corresponds to a lowest determined total inventory management cost;
using a forecasting model to automatically forecast a total future demand value for the consumable based on the demand distribution, the lead time period and a standard error of forecasting adjusted by the selected control parameter; and
if the total future demand value exceeds an inventory position, generating an order for the consumable.

10. The method of claim 9, further comprising:
determining whether the demand distribution comprises a seasonal component; and
if so, selecting, as the forecasting model, a forecasting model having a seasonal component.

11. The method of claim 9, wherein using a forecasting model to automatically forecast a total future demand value comprises:
determining an aggregate future demand value by summing a future demand value for each day in the lead time period;
determining an adjusted standard error of forecasting by multiplying the standard error of forecasting and the selected control parameter; and
forecasting the total future demand value by summing the aggregate future demand value and the adjusted standard error of forecasting.

12. A system of maintaining an inventory of a consumable in a production environment comprising:
a processor; and
a processor readable storage medium in communication with the processor;
wherein the processor readable storage medium contains one or more programming instructions for:
identifying a demand distribution for a consumable in a production environment,
identifying a lead time period for replenishing the consumable,
selecting, from a plurality of candidate parameters, a control parameter that is a function of total inventory management cost so that the selected control parameter corresponds to a lowest determined total inventory management cost,
using a forecasting model to automatically forecast a total future demand value for the consumable based on the lead time period and a standard error of forecasting adjusted by the selected control parameter,
determining whether additional inventory is needed based on at least the total forecasted future demand value and an inventory position, and
if additional inventory is needed, generating an order for the consumable.

13. The system of claim 12, wherein the one or more programming instructions further comprise one or more programming instructions for:
determining whether the demand distribution comprises a seasonal component; and
if so, selecting, as the forecasting model, a forecasting model having a seasonal component.

14. The system of claim 13, wherein the one or more programming instructions for determining whether the demand distribution comprises a seasonal component comprises one or more programming instructions for selecting a SARIMA forecasting model.

15. The system of claim 12, wherein the one or more programming instructions for using a forecasting model comprises one or more programming instructions for summing a future demand value for each day in the lead time period.

16. The system of claim 12, wherein the one or more programming instructions for using a forecasting model comprises one or more programming instructions for:
determining an aggregate future demand value by summing a future demand value for each day in the lead time period;
determining an adjusted standard error of forecasting by multiplying the standard error of forecasting and the selected control parameter; and
forecasting the total future demand value by summing the aggregate future demand value and the adjusted standard error of forecasting.

17. The system of claim 12, wherein the one or more programming instructions for determining whether additional inventory is needed comprises one or more programming instructions for determining whether the total forecasted future demand value exceeds the inventory position.

18. The system of claim 12, wherein the one or more programming instructions for generating an order for the consumable comprises one or more programming instructions for generating an order for an amount of the consumable equal to a difference between the inventory position and the total forecasted future demand.
